(19) United States
(12) Patent Application Publication
(10) Pub. No.: US 2006/0182165 A1
(43) Pub. Date: Aug. 17, 2006

(54) Device for can or bottle to determine temperature and amount of content of beverage

(76) Inventor: Maureen Tapelt-Glaser, Black Creek, WI (US)

Correspondence Address: CONNOLLY BOVE LODGE & HUTZ LLP, SUITE 800, 1990 M STREET NW, WASHINGTON, DC, 20036-3425, US

(21) Appl. No.: 11/057,179

(22) Filed: Feb. 15, 2005

(51) Int. Cl. G01K 11/00

(52) U.S. Cl. 374/162

(57) ABSTRACT

The present invention generally relates to thermometers with components that react to changes in temperature by changing color, such as thermochromic liquid crystals (TLCs). More particularly, the invention concerns an apparatus or article of manufacture comprising a multi-colored decal comprising a plurality of temperature sensors. According to the decal's current temperature, an appropriate one, or more, of the temperature sensors, is (are) activated and thus becomes visible as a change in color.

### FIELD OF THE INVENTION

The present invention generally relates to thermometers with components that react to changes in temperature by changing color, such as thermochromic liquid crystals (TLCs). More particularly, the invention concerns an apparatus or article of manufacture comprising a multi-colored decal comprising a plurality of temperature sensors. According to the decal's current temperature, an appropriate one, or more, of the temperature sensors, is (are) activated and thus becomes visible as a change in color.

### BACKGROUND

The information provided below is not admitted to be prior art to the present invention, but is provided solely to assist the understanding of the reader.

Temperature sensing devices come in a variety of forms, with various underlying scientific principles. One recent type of thermometer uses TLCs, usually constructed in a planar shape. TLCs react to changes in temperature by changing color. These materials are made of twisted molecular structures comprising optically active mixtures of organic chemicals. TLCs include cholesteric compositions, chiral nematic formulations, and combinations of the two.

The molecular structure of a TLC gives the material two indices of refraction causing the material to become birefringent. Birefringence will cause the selectively reflected light emerging from a TLC to become circularly polarized. The reflected color spectrum for most TLC materials will vary continuously from the longer wavelengths (i.e., red) corresponding to the event temperature to shorter wavelengths (i.e., blue) corresponding to the clearing point temperature. Additionally, a TLC material will also transmit a significant amount of the incident light with virtually no modification. Viewing TLCs against a non-reflecting, i.e., black, background prevents this transmitted light from adversely affecting the interpretation of the selectively reflected light. “Temperature-sensitive” mixtures in thin films reflect bright, almost pure colors. They turn from colorless (black, against a black background) to red at a given temperature, and pass through the other colors of the visible spectrum in sequence as temperature increases. This progression includes orange, yellow, green, blue, and violet. At an even higher temperature, the crystals turn colorless (black) again.

The chemical makeup of a TLC material fixes its color-temperature response at the time of manufacture. A simple, two color/temperature designator typically describes this response and can be useful in qualitative applications and for properly selecting a TLC formulation for a particular application. For example, “R35C5W” designates a commonly used TLC formulation. The “R35C” signifies that the red, “R”, start or event temperature of the TLC is 35° C. The “5W” signifies that the blue start temperature is 5° C. above the red start temperature and this provides users with a crude estimate of the formulation's active bandwidth. Narrow-band TLC formulations have bandwidths below 1 or 2° C., while wide-band formulations typically have bandwidths between 5° C. and 20° C. “Off-the-shelf” TLC formulations are available with event temperatures ranging from −30° C. to 100° C. and bandwidths ranging from 0.5° C. to 30° C.

TLCs have been implemented in a variety of forms. One of the most prevalent examples is a temperature strip made by placing numerous TLC rectangles end to end. The rectangles are arranged so that, as the ambient temperature changes from lowest to highest readable temperature, the rectangles are individually illuminated sequentially from one end of the strip to the other. This is done by using bandpass-type TLC rectangles with sequentially increasing activating temperatures. One example is the reversible temperature sensor, part A5321, manufactured by Hallcrest, Inc. of Glenview Ill. With this particular part, the TLC in each rectangle is shaped into numbers defining the corresponding temperature sensed by that rectangle, such as “74”.

TLC materials are used in many different product configurations. For example, some temperature strips are attached to a background border printed with certain textual information. For example, the border may include evenly marked numerical increments of temperature, a temperature scale (e.g., Celsius) that contrasts with that shown on the temperature strip, etc. With other products, the border material includes a cartoon drawing, ruler, or other non-textual information. In some cases, the printed border design provides a decorative function unrelated to the temperature strip; in other configurations, the printed border provides data with some relation to the temperature strip.

U.S. Pat. No. 6,241,386 to Limburg, et al. discloses a decal having a plurality of temperature sensors embedded therein. The decal is in the form of an image, for example an animal, fish, flower, or other such. The image is in the form of multiple features and the various temperature sensors are concealed within the features. The various sensors are separately-activated and de-activated as an ambient temperature changes. The Limburg device does not permit a determination of a temperature gradient. Nor does Limburg permit the determination of the degree to which a beverage container is filled.

U.S. Pat. No. 4,878,588, to Ephraim discloses a baby nursing bottle having a side wall with a sealed, elongated chamber containing a TLC strip thermometer. The thermochromic inks of Ephraim indicate at temperatures approximating 37° C. The Ephraim device is not disposed to indicate a temperature gradient.

Although some of the thermometers discussed above enjoy widespread commercial success today, the present inventors have sought to improve the utility and operation of known thermometers.

Other objects and advantages will become apparent from the following disclosure.

### SUMMARY OF INVENTION

The present invention addresses unfelt needs in the art by providing a thermometer apparatus for indicating a volume-dependent temperature gradient of a beverage container. According to an aspect the present invention provides a thermochromic thermometer comprising an elongate film having a longitudinal void therein, a thermochromic ink disposed within said void, and a covering film having indecia printed thereon.

According to an aspect the present invention provides a thermometer apparatus wherein the thermochromic ink comprises a thermochromic liquid crystal material. According to a further aspect, the thermochromic liquid crystal material is a temperature-sensitive material.

According to an aspect, means are provided to adhere the apparatus to a beverage container. According to a further aspect, the means are adhesive means.

According to an aspect, the present invention provides a thermometric apparatus having indicia affixed thereto. According to a preferred aspect, the indecia comprise a commercial logo. According to a more preferred aspect, the indecia comprise an image of a snowman and an image of an icesicle. According to a further aspect the thermometric apparatus is disposed to appear to be within the icesicle of the indecia.

An aspect of the present invention further provides a method of indicating a volume-dependent temperature gradient of a beverage container comprising providing an elongate thermochromic thermometer, adhering said thermometer to a beverage container, providing an amount of a chilled beverage to said container, wherein said beverage forms a meniscus, and forming a color gradient at said meniscus.

Still other aspects and advantages of the present invention will become readily apparent by those skilled in the art from the following detailed description, wherein it is shown and described preferred embodiments of the invention, simply by way of illustration of the best mode contemplated of carrying out the invention. As will be realized the invention is capable of other and different embodiments, and its several details are capable of modifications in various obvious respects, without departing from the invention. Accordingly, the description is to be regarded as illustrative in nature and not as restrictive.

### BRIEF DESCRIPTION OF DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a schematic of a representative thermometer having a snowman indecia; and

FIG. 2 is a schematic of a side elevation of the thermometer.

It is to be noted, however, that the appended drawings illustrate only typical embodiments of this invention and are therefore not to be considered limiting of its scope, for the invention may admit to other equally effective embodiments.

### DETAILED DESCRIPTION OF A PREFERRED EMBODIMENT

Reference is made to the figure to illustrate selected embodiments and preferred modes of carrying out the invention. It is to be understood that the invention is not hereby limited to those aspects depicted in the figures.

An operator of a bar or tavern may need to know whether a patron may need another beverage serving. Frequently a beverage may be substantially consumed. However, as the beverage is often contained within an opaque container, such as a can, a tavern operator may not be able to tell whether the can is substantially empty. Especially carbonated beverages are desired to be consumed while cold. Frequently, a tavern operator may have difficulty in determining whether a patron's beverage is at a desirable temperature. The present invention addresses these difficulties.

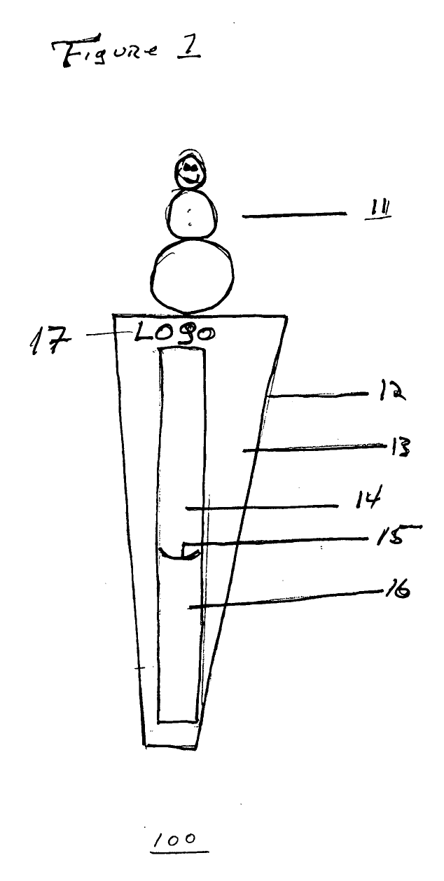

With reference to FIG. 1, the invention provides a thermometer having decorative and functional elements. Numeral 11 indicates a decorative indecia. A preferred indecia is associated with the cold or cold weather. A preferred indecia is a snowman. Thermometer 100 is a substantially flat, elongated member having a front side, visible to an observer and a back side disposed to adhere to a beverage container. Thermometer 100 is preferably a polymer and is provided means to adher to a beverage container. Preferably the means is a glue or other adhesive. More preferably, the adhesive means are reversible so that when not in use the thermometer may be removed from the beverage container. The thermometer comprises a backing area 12 and an indicating area 14. The backing area may be shaped and colored to form any distinctive indecia, such as an icesicle 13. The working portion of thermometer 100 is an elongated region 14-16.

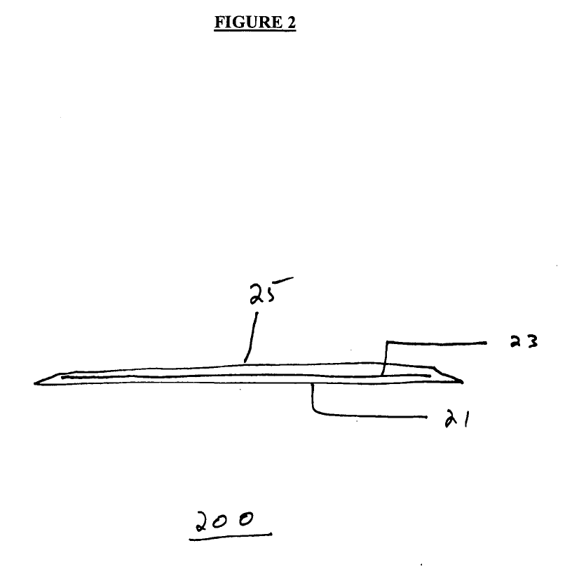

FIG. 2 presents a side elevation of the working portion of the thermometer 200. A backing film 21 is dispodes to contact a substrate, such as a beverage container. The contact surface may be provided an adhesive (not shown). Film 21 is provided a layer 23 of a thermochromic ink. Preferably, film 21 is colored black or is provided with a coat of a black material. A surface film 25 is provided over, and sealed to, film 21, thereby forming a sealed void containing ink layer 23.

Preferably the thermochromic ink is a thermochromic liquid crystal (TLC). TLC react to changes in temperature by changing color. They have chiral (twisted) molecular structures and are optically active mixtures of organic chemicals. The proper name for the materials is cholesteric or chiral nematic liquid crystals. The term cholesteric is an historical one, and derives from the fact that the first materials to show the characteristic properties and structure of this particular type of liquid crystal were esters of cholesterol. This can be misleading, as many non-sterol derived optically active chemicals (and mixtures containing them) also show the cholesteric liquid crystal structure. TLC mixtures can therefore be divided into 3 types based on their compositions: a) cholesteric—comprised entirely of sterol-derived chemicals; b) chiral nematic—comprised entirely of non-sterol based chemicals; and c) combination—containing both cholesteric and chiral nematic components. Combination mixtures extend the working ranges of TLC formulations by combining the respective advantages of both groups of component chemicals.

A preferred TLC is temperature sensitive. Temperature-sensitive mixtures turn from colorless (black against a black background) to red at a given temperature and, as the temperature is increased, pass through the other colors of the visible spectrum in sequence (orange, yellow, green, blue, violet) before turning colorless (black) again at a higher temperature still. The color changes are reversible and on cooling the color change sequence is reversed.

The color change properties of TLC mixtures and products made from them are identified by a code called the color play. This specifies the temperatures at which the colors shown by the TLC change. The color play gives either the red start temperature (R) OR mid-green temperature (MG), the temperature scale (C or F) and the bandwidth (W). For example, R35C1W describes a TLC mixture with a red start at 35° C. and a bandwidth of 1° C., (i.e.) a blue start 1° C. higher at 36° C.; MG60C5W describes a mixture with a mid green at 60° C. and a bandwidth (red start to blue start) of 5° C. Red start temperatures can vary from −30° C. to +120° C. and bandwidths from 0.5° C. to 40° C. Green starts, blue starts, mid greens and clearing points vary accordingly. Bandwidths depend on red start temperatures and tolerances depend on the color play. Preferably, a TLC ink of the present invention has a red start of about 0° C. (about 30° F.) and a bandwidth of about 25° C. The properties of TLC material are given in the Hallcrest, Inc. (Glenview, Ill.) manual, Product Information: Research and Testing Applications, the entire contents of which is hereby incorporated by reference. Thermochronic inks are commercially available and a person of skill will readily be able to obtain such.

In a preferred method of operation, thermometer 100 is applied to a can of a chilled beverage. Typically, a beverage container used by a patron will be only partially full. Typically, therefore, the beverage container will have a lower region 16 occupied by a liquid, such a s a carbonated beverage, and an upper region 14 occupied by air. Typically, there will be a meniscus region 15 at the air-liquid interface. Typically, the air is adjusted to a temperature to suit the comfort of the patrons. Typically, the beverage is chilled to a temperature lower than the air temperature. In operation, the region of ink 16 will have a color either black, if the beverage is colder than the red start temperature of the dye, or a color on the red end of the visible spectrum, according to a temperature above the red start temperature.

In operation region 14 responding to the relatively warmer air temperature will have a color nearer to the blue end of the visible spectrum. As the beverage warms, the color of region 16 progressively shifts towards the blue end of the spectrum. The level of the beverage on the inside of the container is indicated by discontinuity 15 of the colored regions. As the beverage is consumed, the locus of the interface 15 of the colored regions shifts to a lower position. By inspection of the colors of the thermometer, a tavern operator may determine whether the patron might need a refreshed drink.

The foregoing description of the invention illustrates and describes the present invention. Additionally, the disclosure shows and describes only the preferred embodiments of the invention but, as mentioned above, it is to be understood that the invention is capable of use in various other combinations, modifications, and environments and is capable of changes or modifications within the scope of the inventive concept as expressed herein, commensurate with the above teachings and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

### INCORPORATION BY REFERENCE

All publications, patents, and pre-grant patent application publications cited in this specification are herein incorporated by reference, and for any and all purposes, as if each individual publication or patent application were specifically and individually indicated to be incorporated by reference. In the case of inconsistencies the present disclosure will prevail.

Having thus described our invention, what we claim as new, and desire to secure by Letters Patent is:

1. A thermometer apparatus for indicating a volume-dependent temperature gradient of a beverage container comprising:
an elongate film having a longitudinal void therein;
a thermochromic ink disposed within said void; and
a covering film having indecia printed thereon.

2. The thermometer apparatus of claim 1, wherein said thermochromic ink comprises a thermochromic liquid crystal material.

3. The thermometer apparatus of claim 2, wherein said thermochromic liquid crystal material is a temperature-sensitive mixture.

4. The thermometer apparatus of claim 1, further comprising means to adhere said apparatus to a beverage container.

5. The thermometer apparatus of claim 1, wherein said indicia comprise an image of a snowman and an image of an icesicle.

6. The thermometer apparatus of claim 5, wherein said icesicle appears to surround said thermochromic ink.

7. A method of indicating a volume-dependent temperature gradient of a beverage container comprising:
providing an elongate thermochromic thermometer;
adhering said thermometer to a beverage container,
providing an amount of a chilled beverage to said container, wherein said beverage forms a meniscus;
forming a color gradient at said meniscus.

8. The method of claim 7 wherein said thermometer comprises:
an elongate film having a longitudinal void therein;
a thermochromic ink disposed within said void; and
a covering film having indecia printed thereon.

9. The method of claim 7 wherein said indicia comprise an image of a snowman and an image of an icesicle.
